(19) United States
(12) Patent Application Publication
(10) Pub. No.: US 2025/0374138 A1
(43) Pub. Date: Dec. 4, 2025

(54) METHOD FOR LAYER-l/LAYER-2 TRIGGERED CELL SWITCHING AND TIME ADVANCE ACQUISITION IN WIRELESS COMMUNICATION SYSTEM

(71) Applicant: ZTE Corporation, Shenzhen (CN)

(72) Inventors: Fei DONG, Shenzhen (CN); He HUANG, Shenzhen (CN); Jing LIU, Shenzhen (CN); Mengjie ZHANG, Shenzhen (CN)

(21) Appl. No.: 19/300,874

(22) Filed: Aug. 15, 2025

Related U.S. Application Data
(63) Continuation of application No. PCT/CN2023/076881, filed on Feb. 17, 2023.

(51) Int. Cl. H04W 36/04; H04W 36/00; H04W 56/00

(52) U.S. Cl. CPC H04W 36/04; H04W 36/00725; H04W 56/0045

(57) ABSTRACT

This disclosure is directed generally to wireless communication network and particularly to layer-1/layer-2 triggered mobility or cell switching in cellular wireless networks. Specifically, various implementations are disclosed to facilitate an acquisition of Time Advance (TA) of a target or candidate cell in advance of an actual cell switching in order to effectuate more efficient and speedier cell switching. The actual cell switching may be triggered in layer 1 or layer 2 of the wireless network. With the TA acquired in advance, a cell switching based on layer 1/layer 2 triggered mobility (LTM) may be performed free of random-access procedures. The various implementations below further provide detailed example flows for effectuating a configuration for early TA acquisition, example flows for the acquisition of the TA, and examples for the LTM switching based on the acquired TA.

### TECHNICAL FIELD

This disclosure is directed generally to wireless communication network and particularly to layer-1/layer-2 triggered mobility or cell switching in cellular wireless networks.

### BACKGROUND

Mobility of a wireless terminal in a cellular wireless network involves switching from a source cell or a target cell. The source cell and the target cell may be provisioned by a same base station or may be provisioned by different base stations. Cell switching of the wireless terminal may be triggered in lower layers of the wireless network. For example, such cell switching may be triggered in layer 1 or layer 2 of the wireless network. Uplink information from a wireless mobile terminal to a base station may be transmitted incorporating a time advance (TA) in order to take into account the uplink transmission latencies. As such, procedures for acquiring TA for uplink transmission between a mobile terminal and a target cell during or before a cell switching constitute an important part of the wireless network operation.

### SUMMARY

This disclosure is directed generally to wireless communication network and particularly to layer-1/layer-2 triggered mobility or cell switching in cellular wireless networks. Specifically, various implementations are disclosed to facilitate an acquisition of Time Advance (TA) of a target or candidate cell in advance of an actual cell switching in order to effectuate more efficient and speedier cell switching. The actual cell switching may be triggered in layer 1 or layer 2 of the wireless network. With the TA acquired in advance, a cell switching based on layer 1/layer 2 triggered mobility (LTM) may be performed free of random-access procedures. The various implementations below further provide detailed example flows for effectuating a configuration for early TA acquisition, example flows for the acquisition of the TA, and examples for the LTM switching based on the acquired TA.

In one example embodiment, a method performed by a wireless terminal in communication with a current serving cell is disclosed. The method may include receiving, from the current serving cell, a time advance (TA) configuration for assisting in an acquisition of a time advance (TA) associated with a candidate cell; acquiring the TA according to the TA configuration; receiving a layer 1/layer 2 triggered mobility (LTM) command, the LTM command instructing the wireless terminal to perform a cell switch to the candidate cell; and performing a random-access-free cell switch from the current serving cell to the candidate cell according to the LTM command.

In the example embodiment above, acquiring the TA according to the TA configuration may include performing an early random-access procedure on the candidate cell, the early random-access procedure being designed for acquiring time advances rather than for uplink data transmissions.

In any one or the example embodiments above, the early random-access procedure is performed over a set of random-access resources configured in the TA configuration for early random-access. In any one or the example embodiments above, the TA configuration is communicated from the current serving cell to the wireless terminal in a Radio Resource Control (RRC) configuration message.

In any one or the example embodiments above, the set of random-access resources are configured as cell-specific random-access resources for non-exclusive use by the early random-access procedure in a contention-based manner.

In any one or the example embodiments above, set of random-access resources are configure as UE-specific random-access resources dedicated to the wireless terminal for non-exclusive use by the early random-access procedure in a contention-free manner.

In any one or the example embodiments above, the early random-access procedure comprises sending a random-access preamble to the candidate cell; and the method further includes transmitting a control message to the candidate cell, the control message indicating to the candidate cell that the random-access preamble sent by the wireless terminal is for early random-access and TA acquisition rather than uplink transmission.

In any one or the example embodiments above, the set of random-access resources are configured as UE-specific random-access resources dedicated to the wireless terminal for exclusive use by early random-access procedures.

In any one or the example embodiments above, the method further includes determining a random-access type of the early random-access procedure prior to performing the early random-access procedure, the random-access type being one of a contention-based random-access type or a contention-free random-access type.

In any one or the example embodiments above, the method further includes determining that the early random-access procedure is of the contention-based random-access type when the LTM command contains no identifying information of the set of random-access resources.

In any one or the example embodiments above, the method further includes determining that the early random-access procedure is of the contention-free random-access type when the LTM command contains identifying information of UE-specific random-access resources.

In any one or the example embodiments above, determining a random-access type of the early random-access procedure includes extracting an explicit type indicator in an RRC configuration associated with the set of random-access resources configured for early random-access procedures.

In any one or the example embodiments above, the current serving cell is provisioned by a first distributed unit base station and the candidate cell is provisioned by a second distributed unit base station, the second distributed unit base station being different from the first distributed unit base station.

In any one or the example embodiments above, the TA configuration originates from the second distributed unit base station and is transmitted to the first distributed unit base station via a central unit base station prior to being transmitted by the first distributed unit base station and received by the wireless terminal.

In any one or the example embodiments above, the method further includes performing a notification procedure to the current serving cell to indicate to the current serving cell that the wireless terminal is to return to the current serving cell after acquiring the TA.

In any one or the example embodiments above, the notification procedure includes triggering and sending a scheduling request, sending a Sounding Reference Signal (SRS), or sending a Media Access Control (MAC) Control Element (MAC CE) on the current serving cell as soon as the TA associated with the candidate cell is acquired.

In any one or the example embodiments above, the method further includes sending a control message to the first distributed unit base station, the control message including the TA as acquired by the wireless terminal.

In any one or the example embodiments above, the early random-access procedure includes sending a random-access preamble to the candidate cell and receiving a random-access response from the first distributed unit base station associated with the current serving cell as relayed from the second distributed unit base station associated with the candidate cell by a central unit base station.

In any one or the example embodiments above, the early random-access procedure includes sending a random-access preamble to the candidate cell and receiving a random-access response message from the candidate cell containing the TA.

In any one or the example embodiments above, the early random-access procedure includes sending a random-access preamble to the candidate cell and receiving a random-access response message containing the TA associated with the candidate cell from the candidate cell or the current serving cell, immediately followed by a termination of the early random-access procedure.

In any one or the example embodiments above, the current serving cell and the candidate cell are provisioned by a same distributed unit base station; and the early random-access procedure includes sending a random-access preamble to the candidate cell and receiving a random-access response associated with the candidate cell from the same distributed unit base station.

In any one or the example embodiments above, the TA configuration indicates to the wireless terminal that the TA associated with the candidate cell is to be approximated by a cell within a same Time Advance Group (TAG) as the candidate cell; and acquiring the TA according to the TA configuration includes obtaining a known reference TA within the TAG as the TA associated with the candidate cell.

In any one or the example embodiments above, the method further includes performing at least one layer-2 reset operations after receiving the LTM command.

In some other embodiments, an electronic device comprising a processor and a memory is disclosed. The processor may be configured to read computer code from the memory to implement any one of the methods above.

In yet some other embodiments, a computer program product comprising a non-transitory computer-readable program medium with computer code stored thereupon is disclosed. The computer code, when executed by a processor, may cause the processor to implement any one of the methods above.

The above embodiments and other aspects and alternatives of their implementations are described in greater detail in the drawings, the descriptions, and the claims below.

### BRIEF DESCRIPTION OF THE DRAWINGS

FIG. 1 illustrates an example wireless communication network including a wireless access network, a core network, and data networks.

FIG. 2 illustrates an example wireless access network including a plurality of mobile stations/terminals or User Equipments (UEs) and a wireless access network node in communication with one another via an over-the-air radio communication interface.

FIG. 3 shows an example radio access network (RAN) architecture.

FIG. 4 shows an example communication protocol stack in a wireless access network node or wireless terminal device including various network layers.

FIG. 5 shows an example of a random-access procedure performed jointly by a mobile station and a wireless access network node.

FIG. 6 shows an example flow chart for an early RACH preparation stage for obtaining TA in advance for inter-DU (Distributed Unit) or intra-DU Layer 1/layer 2 Triggered Mobility (LTM).

FIG. 7 shows an example flow chart for the early RACH triggering.

FIG. 8 shows an example general flow chart for an early RACH execution for acquisition of the TA.

FIG. 9 shows an example procedure for an LTM cell switching.

### DETAILED DESCRIPTION

The technology and examples of implementations and/or embodiments described in this disclosure can be used to facilitate transmitting and receiving Artificial Intelligence (AI) network management models between various wireless network devices or nodes via at least one over-the-air interface. The term “over-the-air interface” is used interchangeably with “air interface” or “radio interface” in this disclosure. The term “exemplary” is used to mean “an example of” and unless otherwise stated, does not imply an ideal or preferred example, implementation, or embodiment. Section headers are used in the present disclosure to facilitate understanding of the disclosed implementations and are not intended to limit the disclosed technology in the sections only to the corresponding section. The disclosed implementations may be further embodied in a variety of different forms and, therefore, the scope of this disclosure or claimed subject matter is intended to be construed as not being limited to any of the embodiments set forth below. The various implementations may be embodied as methods, devices, components, systems, or non-transitory computer readable media. Accordingly, embodiments of this disclosure may, for example, take the form of hardware, software, firmware or any combination thereof.

This disclosure is generally directed to wireless communication network and particularly to layer-1/layer-2 triggered mobility or cell switching in cellular wireless networks. Specifically, various implementations are disclosed to facilitate an acquisition of Time Advance (TA) of a target or candidate cell in advance of an actual cell switching in order to effectuate more efficient and speedier cell switching. The actual cell switching may be triggered in layer 1 or layer 2 of the wireless network. With the TA acquired in advance, a cell switching based on layer 1/layer 2 triggered mobility (LTM) may be performed free of random-access procedures. The various implementations below further provide detailed example flows for effectuating a configuration for early TA acquisition, example flows for the acquisition of the TA, and examples for the LTM switching based on the acquired TA.

### Wireless Network Overview

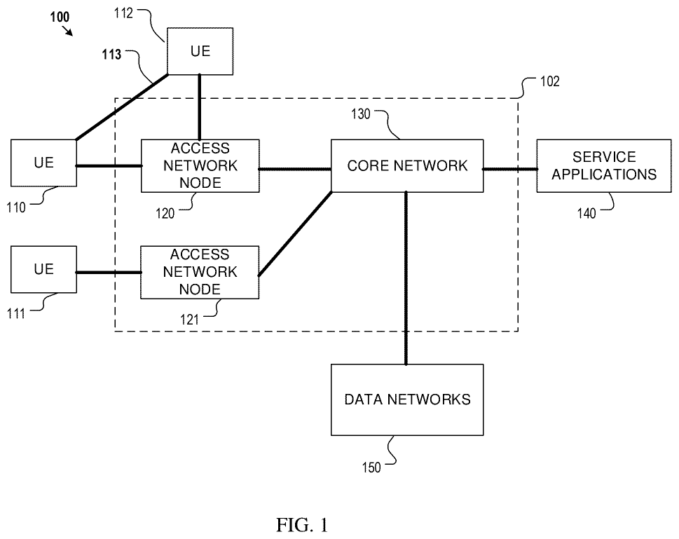

An example wireless communication network, shown as 100 in FIG. 1, may include wireless terminal devices or user equipment (UE) 110, 111, and 112, a carrier network 102, various service applications 140, and other data networks 150. The wireless terminal devices or UEs, may be alternatively referred to as wireless terminals. The carrier network 102, for example, may include access network nodes 120 and 121, and a core network 130. The carrier network 110 may be configured to transmit voice, data, and other information (collectively referred to as data traffic) among UEs 110, 111, and 112, between the UEs and the service applications 140, or between the UEs and the other data networks 150. The access network nodes 120 and 121 may be configured as various wireless access network nodes (WANNs, alternatively referred to as wireless base stations) to interact with the UEs on one side of a communication session and the core network 130 on the other. The term “access network” may be used more broadly to refer a combination of the wireless terminal devices 110, 111, and 112 and the access network nodes 120 and 121. A wireless access network may be alternatively referred to as Radio Access Network (RAN). The core network 130 may include various network nodes configured to control communication sessions and perform network access management and traffic routing. The service applications 140 may be hosted by various application servers deployed outside of but connected to the core network 130. Likewise, the other data networks 150 may also be connected to the core network 130.

In the example wireless communication network of 100 of FIG. 1, the UEs may communicate with one another via the wireless access network. For example, UE 110 and 112 may be connected to and communicate via the same access network node 120. The UEs may communicate with one another via both the access networks and the core network. For example, UE 110 may be connected to the access network node 120 whereas UE 111 may be connected to the access network node 121, and as such, the UE 110 and UE 111 may communicate to one another via the access network nodes 120 and 121, and the core network 130. The UEs may further communicate with the service applications 140 and the data networks 150 via the core network 130. Further, the UEs may communicate to one another directly via side link communications, as shown by 113.

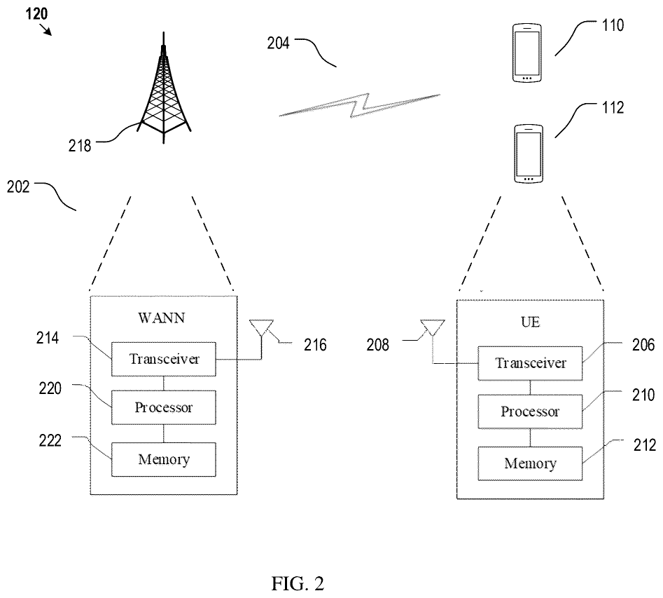

FIG. 2 further shows an example system diagram of the wireless access network 120 including a WANN 202 serving UEs 110 and 112 via the over-the-air interface 204. The wireless transmission resources for the over-the-air interface 204 include a combination of frequency, time, and/or spatial resource. Each of the UEs 110 and 112 may be a mobile or fixed terminal device installed with mobile access units such as SIM/USIM modules for accessing the wireless communication network 100. The UEs 110 and 112 may each be implemented as a terminal device including but not limited to a mobile phone, a smartphone, a tablet, a laptop computer, a vehicle on-board communication equipment, a roadside communication equipment, a sensor device, a smart appliance (such as a television, a refrigerator, and an oven), or other devices that are capable of communicating wirelessly over a network. As shown in FIG. 2, each of the UEs such as UE 112 may include transceiver circuitry 206 coupled to one or more antennas 208 to effectuate wireless communication with the WANN 120 or with another UE such as UE 110. The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the methods described herein.

Similarly, the WANN 120 may include a wireless base station or other wireless network access point capable of communicating wirelessly via the over-the-air interface 204 with one or more UEs and communicating with the core network 130. For example, the WANN 120 may be implemented, without being limited, in the form of a 2G base station, a 3G nodeB, an LTE eNB, a 4G LTE base station, a 5G NR base station of a 5G gNB, a 5G central-unit base station, or a 5G distributed-unit base station. Each type of these WANNs may be configured to perform a corresponding set of wireless network functions. The WANN 202 may include transceiver circuitry 214 coupled to one or more antennas 216, which may include an antenna tower 218 in various forms, to effectuate wireless communications with the UEs 110 and 112. The transceiver circuitry 214 may be coupled to one or more processors 220, which may further be coupled to a memory 222 or other storage devices. The memory 222 may be transitory or non-transitory and may store therein instructions or code that, when read and executed by the one or more processors 220, cause the one or more processors 220 to implement various functions of the WANN 120 described herein.

Data packets in a wireless access network such as the example described in FIG. 2 may be transmitted as protocol data units (PDUs). The data included therein may be packaged as PDUs at various network layers wrapped with nested and/or hierarchical protocol headers. The PDUs may be communicated between a transmitting device or transmitting end (these two terms are used interchangeably) and a receiving device or receiving end (these two terms are also used interchangeably) once a connection (e.g., a radio link control (RRC) connection) is established between the transmitting and receiving ends. Any of the transmitting device or receiving device may be either a wireless terminal device such as device 110 and 120 of FIG. 2 or a wireless access network node such as node 202 of FIG. 2. Each device may both be a transmitting device and receiving device for bi-directional communications.

The core network 130 of FIG. 1 may include various network nodes

geographically distributed and interconnected to provide network coverage of a service region of the carrier network 102. These network nodes may be implemented as dedicated hardware network nodes. Alternatively, these network nodes may be virtualized and implemented as virtual machines or as software entities. These network nodes may each be configured with one or more types of network functions which collectively provide the provisioning and routing functionalities of the core network 130.

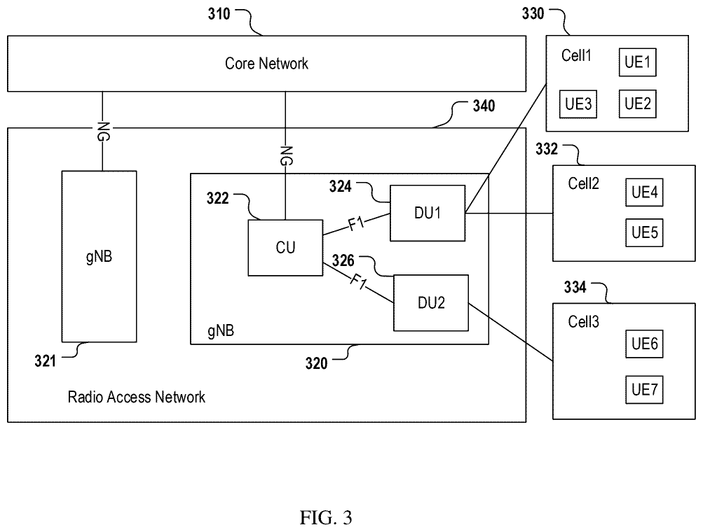

Returning to wireless radio access network (RAN), FIG. 3 illustrates an example RAN 340 in communication with a core network 310 and wireless terminals UE1 to UE7. The RAN 340 may include one or more various types of wireless base station or WANNs 320 and 321 which may include but are not limited to gNB, eNodeB, NodeB, or other type of base stations. The RAN 340 may be backhauled to the core network 310. The WANNs 320, for example, may further include multiple separate access network nodes in the form of a Central Unit (CU) 322 and one or more Distributed Unit (DU) 324 and 326. The CU 322 is connected with DU1 324 and DU2 326 via various interfaces, for example, an F1 interface. The F1 interface, for example, may further include an F1-C interface and an F1-U interface, which may be used to carry control plane information and user plane data, respectively. In some embodiments, the CU may be a gNB Central Unit (gNB-CU), and the DU may be a gNB Distributed Unit (gNB-DU). While the various implementations described below are provided in the context of a 5G cellular wireless network, the underlying principles described herein are applicable to other types of radio access networks including but not limited to other generations of cellular network, as well as Wi-Fi, Bluetooth, ZigBee, and WiMax networks.

The UEs may be connected to the network via the WANNs 320 over an air interface. The UEs may be served by at least one cell. Each cell is associated with a coverage area. These cells may be alternatively referred to as serving cells. The coverage areas between cells may partially overlap. Each UE may be actively communicating with at least one cell while may be potentially connected or connectable to more than one cell. In the example of FIG. 1, UE1, UE2, and UE3 may be served by cell1 330 of the DU1, whereas UE4 and UE5 may be served by cell2 332 of the DU1, and UE6 and UE7 may be served by cell3 associated with DU2. In some implementations, a UE may be served simultaneously by two or more cells. Each of the UE may be mobile and the signal strength and quality from the various cells at the UE may depend on the UE location and mobility.

In some example implementations, the cells shown in FIG. 3 may be alternatively referred to as serving cells. The serving cells may be grouped into serving cell groups (CGs). A serving cell group may be either a Master CG (MCG) or Secondary CG (SCG). Within each type of cell groups, there may be one primary cell and one or more secondary cells. A primary cell in a MSG, for example, may be referred to as a PCell, whereas a primary cell in a SCG may be referred to as PScell. Secondary cells in either an MCG or an SCG may be all referred to as SCell. The primary cells including PCell and PScell may be collectively referred to as spCell (special Cell). All these cells may be referred to as serving cells or cells. The term “cell” and “serving cell” may be used interchangeably in a general manner unless specifically differentiated. The term “serving cell” may refer to a cell that is serving, will serve, or may serve the UE. In other words, a “serving cell” may not be currently serving the UE. While the various embodiment described below may at times be referred to one of the types of serving cells above, the underlying principles apply to all types of serving cells in both types of serving cell groups.

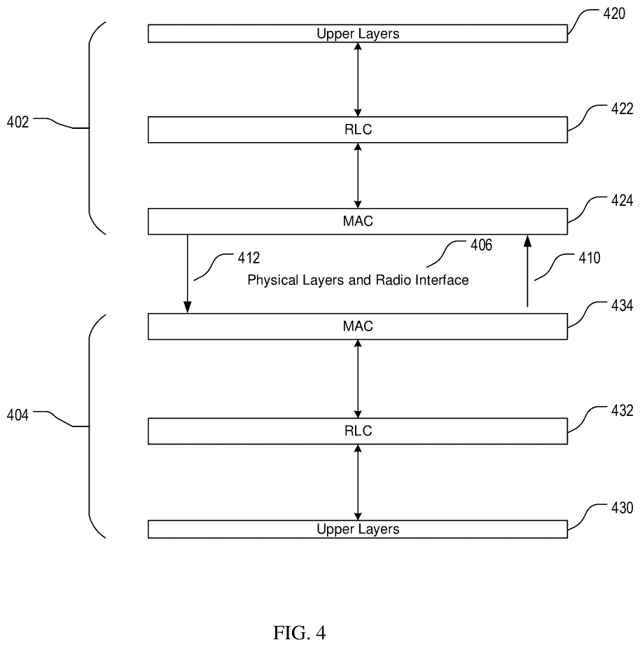

FIG. 4 further illustrates a simplified view of the various network layers involved in transmitting user-plane PDUs from a transmitting device 402 to a receiving device 404 in the example wireless access network of FIGS. 1-3. FIG. 4 is not intended to be inclusive of all essential device components or network layers for handling the transmission of the PDUs. FIG. 4 illustrates that the data packaged by upper network layers 420 at the transmitting device 402 may be transmitted to corresponding upper layer 430 (such as radio resource control or RRC layer) at the receiving device 304 via Packet Data Convergence Protocol layer (PDCP layer, not shown in FIG. 4) and radio link control (RLC) layer 422 and of the transmitting device, the physical (PHY) layers of the transmitting and receiving devices and the radio interface, as shown as 406, and the media access control (MAC) layer 434 and RLC layer 432 of the receiving device. Various network entities in each of these layers may be configured to handle the transmission and retransmission of the PDUs.

In FIG. 4, the upper layers 420 may be referred as layer-3 or L3, whereas the intermediate layers such as the RLC layer and/or the MAC layer and/or the PDCP layer (not shown in FIG. 4) may be collectively referred to as layer-2, or L2, and the term layer-1 is used to refer to layers such as the physical layer and the radio interface-associated layers. In some instances, the term “low layer” may be used to refer to a collection of L1 and L2, whereas the term “high layer” may be used to refer to layer-3. In some situations, the term “lower layer” may be used to refer to a layer among L1, L2, and L3 that are lower than a current reference layer. Control signaling may be initiated and triggered at each of L1 through L3 and within the various network layers therein. These signaling messages may be encapsulated and cascaded into lower layer packages and transmitted via allocated control or data over-the-air radio resources and interfaces. The term “layer” generally includes various corresponding entities thereof. For example, a MAC layer encompasses corresponding MAC entities that may be created. The layer-1, for example, encompasses PHY entities. The layer-2, for another example encompasses MAC layers/entities, RLC layers/entities, service data adaptation protocol (SDAP) layers and/or PDCP layers/entities.

### Random-Access Procedures

Returning to FIG. 1, UEs may be in communication with the WANNs 120 and 121 using wireless network communication resources allocated by the WANNs. Such wireless network communication resources may include but are not limited to radio frequency carrier frequencies and time slots. Unlike traditional circuit-switched communication system based on pre-assigned and dedicated communication channels, wireless access network may be more efficiently implemented at least partially using random access. In particular, a user mobile station may request access to network communication resources at random times and as needed. Network resources and synchronization information may be made available and assigned by the WANNs upon random access request by a user mobile station. In some implementations, requests for random access by the mobile stations may be transmitted via one or more random access communication resources or random-access channels (RACH). Information about RACH allocation and assignment may be provided to the UE from the WANNs during an initial communication establishment procedure. For example, Random access communication resources configuration may be included in random access channel configuration messages (e.g., an RRC message)) generated by the WANNs. The RACH configuration messages may be broadcasted by the WANNs to the user mobile stations. A user mobile station may select a RACH among all RACHs that are available according a RACH configuration message for transmitting a random-access request to the WANNs. The term “channel” is used herein to broadly refer to network transmission resources, including but not limited to any combination of transmission carrier frequencies and time slots.

With respect to the allocation of random channel resources among the UEs, random access may be contention based or contention free, referred to as CBRA (Contention-Based Random Access) or CFRA (Contention-Free Random Access), respectively. In CFRA, random access communication resources such as a RACH may be UE-dedicated whereas in CBRA, random access communication resources may be shared among UEs and thus contention may occur.

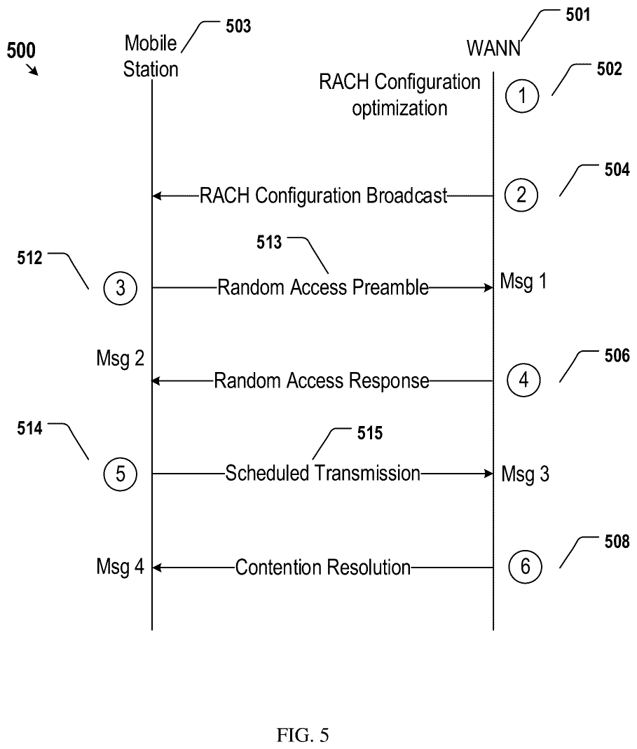

FIG. 5 illustrates an example implementation of a CBRA request and allocation procedure 500. The contention-based RACH procedure starts at step 1 (502) in which the WANN 501 performs optimization for RACH configuration to obtain an optimized RACH configuration. The optimization of the RACH configuration may involve designing RACH preambles according to various network operational parameters available at the WANN for optimizing RACH efficiency and for reducing potential contention among user mobile stations. Once the optimized RACH configuration is determined, the WANN may broadcast the optimized RACH configuration via, for example, a predetermined control channel. For example, the optimized RACH configuration may be broadcasted in step 2 (504) as part of the synchronization signal and physical broadcast channel block (SSB).

Continuing with FIG. 5 and at step 3 (512), the user mobile station 503 receives the optimized RACH configuration broadcasted by the MANN 501. The user mobile station then selects a random-access preamble from the plurality of random-access preambles indicated as available in the optimized RACH configuration and communicates the selection to the MANN, as shown by 513. The MANN receives the preamble selection from the user mobile station and provides response to the mobile station at step 4 (506). The response may include network resources allocated for the mobile station for transmission to the MANN and time advance (TA) information (to be described in further detail below). The mobile station receives the response at step 5 (514) and extracts, for example, the allocated network resources and TA from the response. The mobile station then prepares its transmitter to schedule transmission and transmits information using, for example, the allocated network resources to the MANN and the TA, as shown by 515. The random access by the mobile station is then determined to be established if no network resource contention from other user mobile stations is present. Otherwise, the WANN proceeds to resolve the contention in step 6 (508) before the random access by the user mobile station 503 is either allowed to be established or disallowed to make the allocated network resources available to some other contending user mobile station.

The CBRA implementation of FIG. 5 may be referred to as a 4-step process. The four steps refer to the transmission of messages 513 (preamble from mobile station to WANN), 506 (Random Access Response (RAR) from the WANN to the mobile station), 515 (scheduled transmission of data from the mobile station to the WANN), and 508 (for contention resolution). These four messages may be respectively referred to as Msg 1, Msg 2, Msg 3, and Msg 4.

In CFRA, when the UE uses dedicated random-access preambles, there would not be any need for contention resolution.

In some other example alternative implementations, a 2-step rather than a 4-step RACH procedure are used. In an example 2-step RACH process, the Msg 1 and Msg 3 described above may be combined to include both a RACH preamble and data, referred to as MSGA, and the Msg 2 and Msg 4 above may be combined into one response message, referred to as MSGB. The UE retries the procedure if there was contention and the transmission failed.

### Time Advance (TA)

For communication in the air interface from each UE to the base station, a timing of an uplink transmission may be controlled according to a Time Advance (TA). The time advance for each UE with respect to a base station helps ensure that uplink transmissions from all UEs are synchronized when received by the base station. The TA for a particular UE in communication with a base station is essentially dependent on a transmission propagation delay which is directly related to a path length from the UE to the base station (the DU above). A UE generally needs to acquire and maintain its TA in relation to a base station to which it communicates in order to effectively control the timing of its uplink signal transmission using any allocated uplink transmission resources.

In a wireless connection based on a random-access procedure, the TA may be initially communicated from the base station to the UE during a random-access process in a Random-Access Response (RAR) after a random-access request by the UE (e.g., as described above in relation to FIG. 5 for CBRA). A time advance may be also communicated to the UE via a MAC Control Element (MAC CE) including a Timing Advance Command (TAC).

Layer 1/Layer 2 Triggered Mobility (LTM) and Advance Retrieval of Candidate Cell TA

In some implementations for UE mobility from one cell to another, cell switch of a UE may be triggered in Layer 1 or Layer 2 described above. Such UE mobility may be referred to as Layer 1/Layer 2 Triggered Mobility (LTM). Signaling for LTM may be performed using either a RACH-based solution or a RACH-free solution. For the RACH-based LTM, the switching and access to a candidate cell may be requested and implemented via either the contention-based or contention free random-access process described above. In such cases, TA information that is desired for subsequent uplink transmission and communication may be obtained from a RAR in such random-access procedure. However, for RACH-free LTM, in which a switch to a candidate cell and subsequent uplink communication involve no random-access procedures, the TA information must be obtained in advance in order to determining the timing of the uplink communication. As such, in some implementations, whether a RACH-free or RACH-based LTM is used may depend on whether the TA information is available at the UE with respect to the candidate cell. The terms “candidate cell” and “target cell” are used interchangeably in this disclosure.

In some example implementations, in anticipation of or in preparation for a RACH-free LTM, a PDCCH-ordered (Physical Downlink Control Channel-ordered) RACH procedure may be initiated for the purpose of acquiring the TA value of the candidate cell in advance so that it is available for the RACH-free LTM. Such a PDCCH ordered RACH is essentially a random-access procedure triggered by a PDCCH order or command (e.g., a DCI message). For example, cell-specific RACH resources may be allocated by the base station and indicated in a PDCCH order for a UE currently connected with a source serving cell to send a RACH request (e.g. Preamble) to a candidate cell and to receive an RAR containing the TA associated with the candidate cell in response to the RACH request. Once the TA of the candidate cell is obtained, the UE would then switch back to the source cell, and the TA would be available for a potential RACH-free LTM. The PDCCH ordered RACH can be either CFRA (e.g., with a Preamble ID present in PDCCH order that is not 0b000000) or CBRA (e.g., with a Preamble ID present in PDCCH order that is 0b000000).

In some example implementations, the RAR reception and preamble transmission in PDCCH ordered RACH may be performed on different serving cells. For example, the UE may transmit the preamble to the candidate cell upon receiving the PDCCH order on the source cell and may receive an RAR carrying a candidate cell TA on the source cell. Such implementations can operate when the source cell and the candidate cell belong to and are controlled/coordinated by a same DU. For inter-DU LTM, where the candidate cell and source cell belong to different DUs, such PDCCH ordered RACH procedure for obtaining candidate cell TA in advance and involving no inter-DU communication may not be effective.

The various disclosed implementations below describes example manners in which TA of a candidate cell are obtained in advance via early RACH procedures in order facilitate inter-DU or intra-DU RACH-free LTM with or without the PDCCH ordered RACH. The term “early RACH” is used to indicate that such a RACH process for the purpose of obtaining TA is earlier than the actual LTM based switching.

In addition, when performing LTM, user plane (UP) data transmission interruption should be avoided/minimized as much as possible. As such, details in L2 operation are critical for LTM procedure. The various implementations below further provide example manners in which the LTM procedures are carried out with reduced or minimized UP data interruption.

### Early RACH Preparation/Configuration

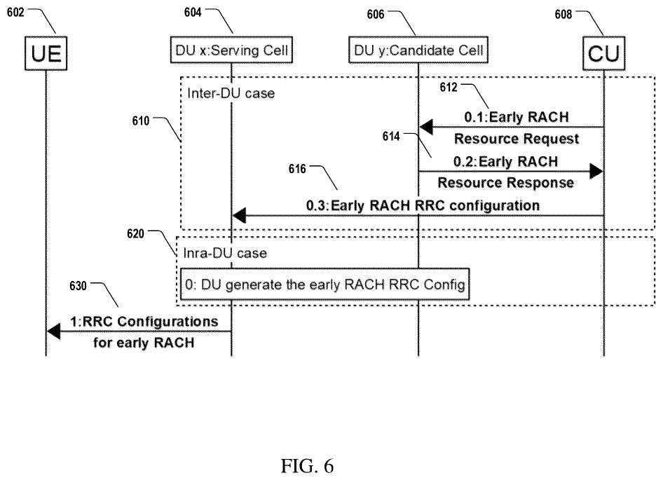

In preparation for early RACH procedure for the purpose of obtaining TA of a candidate cell, the RACH resources for the early RACH should be configured first. An example implementation is shown in FIG. 6. FIG. 6 shows UE 602 in communication with a current serving cell 604 (or source serving cell) belonging to DUx and potentially subject to LTM to a candidate or candidate serving cell 606 belonging to DUy. DUx and DUy represent different DUs for inter-DU LTM whereas Dux and DUy represent a same DU for intra-DU LTM. Both DUx and DUy are provisioned by the CU 608. The term “serving cell” may be alternatively referred to in the similar form as “cell”.

The early RACH preparation and configuration may involve the following example steps.

In STEP 0 and for the inter-DU case, as shown by 610, early RACH resource configuration in the candidate cell may be allocated by the candidate cell 606 with the DUy and communicated to the current source cell 604 with DUx via the CU 608. The CU 608 may be relied on as an intermediate network node for this early RACH configuration in that the DUx and the DUy do not communicate directly but can communicate via the CU 608. STEP 0 for the inter-DU case may thus include the following sub steps.
STEP 0.1: The CU 608 may generate an Early RACH Resource Request Message 612 and transmit it to the DUy to which the candidate cell 606 belongs.
STEP 0.2: The DUy to which the candidate cell 606 belongs may generate an Early RACH Resource Response and transmit it to the CU 608.
STEP 0.3: An RRC Configuration 616 for the early RACH to obtain the TA value of the candidate cell 606 is then forwarded to the DUx to which the source cell 604 belongs.

In STEP 0 and for the intra-DU case, as shown by 620, the early RACH resource configuration may be generated by the DU the candidate cell 606 and current source cell 604 belong to and there is no need for any CU involvement. In other words, since the candidate cell 606 and the source cell 604 share the same DU, the shared DU would direct generate RRC configuration for the early RACH resources with respect to the candidate cell.

In STEP 1, for both inter-DU and intra-DU cases, the RRC configuration generated in STEP 0 for the early RACH may then be transmitted from the source cell 604 to the UE 602 by the DUx.

In some example implementations, the PRACH resources (e.g. RACH occasion and/or Preamble) of the early RACH may be configured within a cell specific RACH configuration, e.g., the RRC configuration for the early RACH may be specific to the candidate cell 606. In some example implementations, the configured PRACH resources for early RACH may be shared with CBRA for LTM. In such implementations, the resources for the early RACH may be configured within, e.g., RACH-ConfigCommon. In such situations, various implementations may be designed in order for the candidate cell 606 to distinguish between an early RACH request and a RACH request for LTM switching to the candidate cell, as described in further detail below.

In some other example implementations, the PRACH resources (e.g. RACH occasion and/or Preamble) of the early RACH may be configured within a UE specific or dedicated RACH configuration. In such implementations, the PRACH resources for the early RACH may be configured within, e.g., RACH-ConfigDedicated. In some example implementations, such dedicated PRACH resources for early RACH may be shared with LTM based on CFRA. In such situations, various implementations may be designed in order for the candidate cell 606 to distinguish between an early RACH request and a RACH request for LTM using UE-specific RACH resources, as described in further detail below.

In some other example implementation, the RACH resources in the candidate cell dedicated to the UE for early RACH may be separately configured from the RACH resources used by the UE to perform RACH for LTM based Cell switch. For example, the PRACH resources for early RACH may be separate from the PRACH resources for RACH procedures in LTM Cell switch. In one implementation of this example, RACH occasions configured for early RACH may be separate from the RACH occasions used for RACH in LTM Cell switch. In another implementation of this example, the RACH preamble resources for early RACH may be separate from the RACH preamble resources used for RACH in LTM Cell switch.

In some example implementations, an additional step may precede STEP 0 above for the inter-DU case. Specifically, the source cell 604 associated with DUx may first transmit an early RACH resource request message to the CU 608 to trigger the CU 608 to transmit its early RACH resource request 612 to the candidate cell 606 associated with DUy.

### Early RACH Triggering

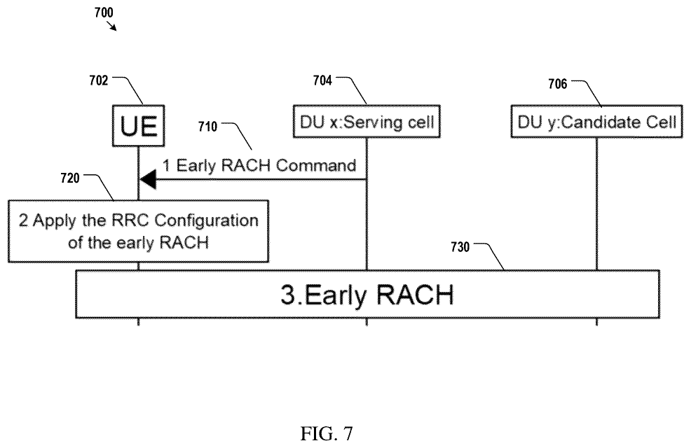

Once the early RACH resources in the candidate cell are configured, they may be used for the UE to perform the early RACH procedure with the candidate cell in order to obtain the TA in advance of any actual LTM based cell switch. An example for triggering such an early RACH procedure is shown in the flow chart 700 of FIG. 7. The flow chart 700 may include the following example steps.

In STEP 1, the source serving cell 704 associated with DU x may transmit an Early RACH Command 710 to the UE 702 for initiating the early RACH on candidate cell 706 for acquiring the TA of the candidate cell 706.

In some example implementations, the early RACH Command 710 may be transmitted as an L1 signaling (e.g., a DCI image), which may include at least one of the following information:
Candidate Cell Group ID to identify the Candidate cell group associated with the candidate cell 700 whose TA value is to be acquired.
Candidate Cell ID to identify the candidate cell 706 whose TA value is to be acquired.
SSB or CSI-RS ID to indicate one or more SSBs or CSI-RS's to be selected for RACH resource selection when initiating the early RACH according to a mappping between these reference signals and RACH resources.
Preamble ID field to indicate a Preamble to be selected when initiating the early RACH. When the value of such a field is present as 0B000000, CBRA shall be applied for the early RACH procedure in which the actual RACH preamble may be selected by a MAC entity.
RACH Occasion (RO) ID(s) or/and Physical RACH (PRACH) MASK(s) to indicate one or more RACH occasions to be selected to transmit the RACH preamble when initiating the early RACH procedure with the candidate cell.
RACH resource pool Indicator to indicate which RACH resource pool is to be used for initiating the early RACH procedure with the candidate cell.

In some other implementations, the early RACH Command 710 may be implemented as an L2 signaling (e.g., a MAC CE). For example, such a MAC CE may be implemented as a same type of MAC CE for triggering the actual LTM cell switching (e.g., RACH-based LTM cell switching). In such implementations, for distinguishing the usage of the early RACH for acquiring the TA from the usage of LTM RACH by the target or candidate cell, an indication filed may be included in the MAC CE. For example, if such a field is set to 1, it may mean that the MAC CE is for triggering an early RACH to acquire TA. Otherwise, if such a filed is set to 0, it may mean that the MAC CE is for triggering LTM based cell switch. Such a MAC CE command to trigger the earlier RACH procedure may include at least one of the information items listed above for the L1 layer implementation of the early RACH command 710.

In STEP 2 of FIG. 7, the UE 702 may apply the configuration of the early RACH (e.g., RRC configuration of the early RACH) according to the received early RACH command 710, as shown by 720. Such configuration may include determining the

RACH resources (the Rach preamble, the RACH occasions, channels, and the like) and/or determining the parameters related to RACH procedure (the maximum preamble transmission times, the Reference Signal Received Power (RSRP) threshold for SSB or CSI-RS selection).

In STEP 3 of FIG. 7, the UE 702 may determine a RACH type (e.g., CFRA or CBRA) for the early RACH procedure according to the received early RACH command and/or applied RRC configuration of the early RACH, and initiate the early RACH procedure according to the applied RRC configuration of the RACH and the received early RACH command, as shown by box 730 of FIG. 7.

In the example implementations above for STEP 3 (730 of FIG. 7), the early RACH procedure as initiated by the UE may be of CFRA (contention-free RACH) or CBRA (contention-based RACH) type. For the CFRA type of early RACH procedure, the PRACH resources used therein may be deliberately or dedicatedly allocated to the UE via RRC configuration or early RACH command as described above. For the CBRA type of early RACH procedure, the PRACH resources used therein may be selected by a MAC entity of the UE from allocated common PRACH resources that may need contention resolution with other UEs. In some example implementations, if the CBRA type of early RACH procedure is initiated, the Msg 3 and Msg 4 of the normal RACH procedure shown in FIG. 5 and described above may no longer be needed, as the sole purpose of the early RACH procedure for the UE is to obtain the TA in advance of LTM, and unlike a normal RACH procedure, there is no intention of actually making any uplink transmission. In other words, UE may consider the CBRA based early RACH as being successfully terminated when successfully receiving and decoding the RAR (i.e., Msg 2 of FIG. 5).

The UE may determine the type of the early RACH procedure (CBRA or CFRA) in various example manners:
If the PRACH Resources (e.g., Preamble ID and/or PRACH MASK) and SSB ID/CSI-RS ID is not present in the early RACH command 710 or the PRACH Resource such as the preamble ID is present as 0b000000 in the early RACH command, then the UE may determine that the early RACH procedure is of CBRA type. Otherwise, the early RACH procedure may be determined as CFRA type.
If the PRACH resources indicated by the early RACH command is from the UE dedicated RACH resources, then the UE may determine that the early RACH procedure is of CFRA type. However, if the PRACH resources indicated by the early RACH Command is from the cell specific RACH resources, then the UE may determine that the early RACH procedure is of CBRA type.
The RACH type for the early RACH may be indicated by an information element configured in the RRC configuration associated with the candidate cell, and they UE may determine the type for the early RACH procedure based on that RRC information element.

In some example implementations, as described above, the RACH resources for the early RACH procedure may be also shared with the RACH sources for LTM based cell switch. In such situations, if the early RACH procedure is targeting a candidate cell belonging to a different DU from the DU associated with the current serving cell (inter-DU situation), the candidate cell may follow various example solutions in order to distinguish between an early RACH request and a RACH request for LTM.

Such solutions may be RRC-based. For example, when UE-specific RACH resources are used, the PRACH resources for early RACH may be separated from the PRACH resources for the RACH-based LTM. In other words, some UE-specific RACH resources may be configured as being dedicated to the early RACH procedure whereas some other UE-specific RACH resources may be configured as being dedicated to the RACH procedure for RACH-based LTM. The candidate cell thus can distinguish an early RACH request and a RACH request for LTM-based cell switch based on what RACH resources are used for the received request.

Such solutions may alternative be based on MAC CE. For example, in the case of early CFRA, the UE, after sending the early RACH request and receiving an RAR from the candidate cell, may additionally send a MAC CE to the candidate cell with the UL grant included the received RAR to notify the candidate cell of what the RACH was for (e.g., whether it was and early RACH for acquiring the TA or a RACH procedure for RACH-based LTM). In some example implementations, a presence of a C-RNTI MAC CE in a UL transmission by the UE using the UL grant indicated in the RAR received from the candidate cell may be considered by the candidate cell as an indication that this current RACH is for LTM based cell switching. Otherwise, when UL transmission by the UE using the UL grant indicated in the received RAR or the UL grant indicated in the received RAR is ignored by the UE or an UL transmission with zero-padding is received by the candidate cell, for example, it may be considered as an indication that the current RACH procedure is an early RACH for obtaining TA acquisition only. In another example implementations, a presence of a specific UL MAC CE in a UL transmission by the UE using the UL grant indicated in the RAR received from the candidate cell may be considered by the candidate cell as an indication that this current RACH is a early RACH for acquiring a TA. In this example implementation, the specific UL MAC CE is a MAC CE only contain the subheader without any payload information.

For another example, in the case of early CBRA, in one example implementation, the UE may terminate an early RACH procedure when successfully receiving and encoding the RAR without UL transmission (or Msg 3 in FIG. 5). In that situation, the candidate cell, without receiving any UL transmission based on the RAR, may determine that current RACH procedure (associated with the RAR it just sent to the UE) is an early RACH procedure for the acquisition of TA. In another example implementation, the UE may include a specific UL MAC CE in the UL transmission (or Msg.3 in FIG. 5) by using the UL grant indicated in the RAR to inform the candidate cell that this RACH is an early RACH for acquiring the TA value. In this example implementation, the specific UL MAC CE is a MAC CE only contain the subheader without any payload information.

### Early RACH Execution

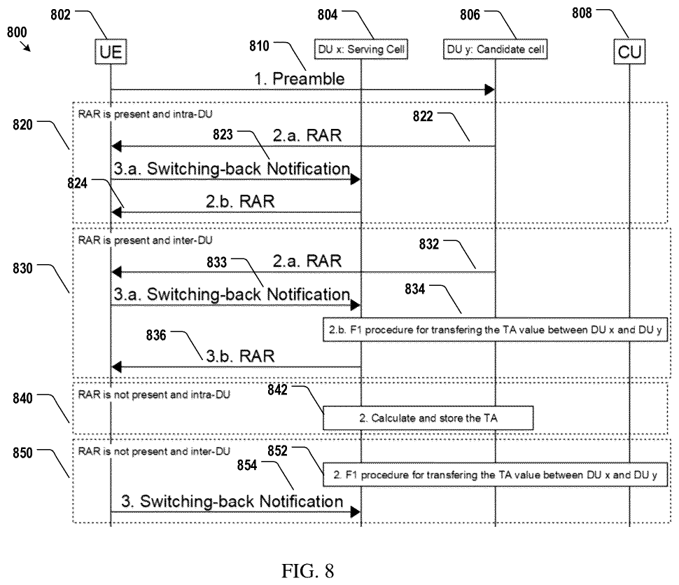

Example implementations for the actual early RACH procedure of 730 of FIG. 7 are shown in further detail as flow chart 800 in FIG. 8. As shown in FIG. 8, in STEP 1, the UE 802 may first send a RACH preamble 810 for early RACH to the candidate cell 806 as indicated by the early RACH command described above. After that, the example early RACH procedure may vary in details depending on whether the DUs associated with the current serving cell and the candidate cell are different (inter-DU) or the same (intra-DU). In addition, the example early RACH procedure may or may not require an RAR. As such, four different scenarios may be possible: (1) intra-DU with RAR; (2) inter-DU with RAR; (3) intra-DU without RAR; and (4) inter-DU without RAR, with the corresponding example early RACH procedure shown in the dashed boxes of 820, 830, 840, and 850, respectively.

In the example procedure 820, where current serving cell 804 and the candidate cell 806 belong to a same DU (intra-DU where DUx and DUy are the same DU) and RAR is used to convey the TA, the following steps for the early RACH procedure may be implemented after the above STEP 1 of sending RACH preamble 810:
In STEP 2.a., the candidate cell sends an RAR 822 to the UE and the TA information of the candidate cell 806 may be included in this RAR.
In STEP 3.a., for notifying the current serving cell 804 of the UE 802 of a switching back to the current serving cell 804, the UE may generate switching-back notification 823 to the current serving cell 804. In some implementations, this step may not be needed since the current serving cell and the candidate cell are provisioned by the same DU.

Alternatively, STEP 2 may be implemented as STEP 2.b. in FIG. 8 where the current serving cell 804 rather than the candidate cell 806 send an RAR 824 to the UE and the TA information of the candidate cell is included in the RAR. This is possible because the current serving cell 804 and the candidate cell 806 belong to the same DU and thus the RAR processing can be handled in a unified manner. In this alternative, the current serving cell would know that UE would automatically switching-back to receive the RAR within the RA response window.

In the example procedure 830, where current serving cell 804 and the candidate cell 806 belong to different DUs (inter-DU where DUx and DUy are different DUs) and RAR is used by to convey the TA, the following steps for the early RACH procedure may be implemented after the above STEP 1 of sending RACH preamble 810:
In STEP 2.a., the candidate cell 806 may send an RAR 832 to the UE 802 and the TA information of the candidate cell 806 may be included in this RAR.
In STEP 3.a., for notifying the current serving cell 804 of the UE 802 of a switching back to the current serving cell 804, the UE may generate a switching-back notification 833 to the current serving cell 804.

Alternatively, STEP 2.a. and STEP 3.a. above may be implemented as STEP 2.b. and STEP 3.b. below and in FIG. 8:
In STEP 2.b., the DUy associated with the candidate cell 806 may initiate, for example, an F1 interface procedure in order to inform DUx associated with the current cell 804 of the TA information of the candidate cell 806.
In STEP 3.b, the current serving cell 804 of the DUx may generate and send an RAR 836 to the UE where the TA value of the candidate cell 806 are included in this RAR.

In the example procedure 840, where current serving cell 804 and the candidate cell 806 belong to a same DU (intra-DU where DUx and DUy are the same DU) and RAR is not used to convey the TA, the following STEP 2 as indicated by 842 for the early RACH procedure may be implemented after the above STEP 1 of sending RACH preamble 810: the DU (same DU for both the candidate cell 806 and the current serving cell 804) may calculate the TA value of the candidate cell 806 via early RACH. This is possible because the DU has direct information of both cells.

In the example procedure 850, where current serving cell 804 and the candidate cell 806 belong to different DUs (inter-DU where DUx and DUy are different DUs) and RAR is not used to convey the TA, the following steps may be implemented after the above STEP 1 of sending RACH preamble 810:
STEP 2: The DUy associated with the candidate cell 806 may initiate, for example, an F1 interface procedure in order to inform DUx associated with the current serving cell 804 of the TA information of the candidate cell, as indicated by 852. The DUx may consequently maintain the acquired TA of the candidate cell 806 or send the acquired TA to the UE 802 to maintain.
STEP 3: The UE 802 notifies the DUx associated with the current serving cell 804 of a switching back to the current serving cell 804, as indicated by 854.

In some example implementations of 830 and 850 (inter-DU cases), additional procedure may be considered in order to ensure that the current serving cell 804 and its DUx is made aware that the UE is coming back to the current serving cell after acquiring the TA.

For example, the UE 802 may trigger and send a Scheduling Request (SR) to the current serving cell 804 as soon as the UE returns to the current serving cell 804 after acquiring the TA of the candidate cell 806. For another example, the UE 802 may send a Sounding Reference Signal (SRS) to the current serving cell 806 to indicate to the current serving cell of its return.

For another example, the UE 802 may generate and send a UL MAC CE to the current serving cell 806 after obtaining the TA of the candidate cell 806 or sending the preamble to the candidate cell 806 in order to inform of the switching-back. In one example implementation, an SR may be triggered when there is no UL-SCH resources for source serving cell 804 available to accommodate the triggered UL MAC CE. In another example, the UL MAC CE may be the UL time Advance Sync MAC CE as described below.

For another example, when RAR is not present, a timing of when DUx receives the F1 message 852 from the DUy containing the TA information associated with UE and the candidate cell may be used as an indication of returning of the UE to the current serving cell 804.

For yet another example, the current serving cell 804 or candidate cell 806 may configure an EarlyRACH-ControlTimer for the UE 802 to initiate the early RACH procedure with the candidate cell 806. For example, the EarlyRACH-ControlTimer may be a number of the times of preamble transmission for performing the early RACH. For another example, the EarlyRACH-ControlTimer may be a number of milliseconds for performing the early RACH. Functions of this timer at UE 802 side may be configured as below:
Start/Restart upon the reception of the early RACH command.
Stop upon the reception of the RAR or switch back to the serving cell 804 or reception of the DCI addressed by C-RNTI for UL transmission or DL transmission.
Upon expiration, stop the ongoing early RACH, if any, and switch back to the current serving cell 804 immediately.

In the example implementations in the intra-DU situation, assuming that RAR is present from the candidate cell 806 (820 of FIG. 8), the RAR (e.g., in 824) may nevertheless include an UL grant of the current serving cell 804 which may then be used by the UE to inform the current serving cell 804 of its return after the acquisition of the TA of the candidate cell 806.

In the example implementations of inter-DU case 830 above, in which RAR is received from the candidate cell 806 by the UE 802, additional procedure may be implemented in order for the UE 802 to inform the received TA information of the candidate cell 806 to the current serving cell 804. For example, a UL MAC CE (e.g., UL TA Sync MAC CE) may be used to inform the current serving cell 804 of a Time Alignment Timer (TAT) value of the candidate cell 806 that has been successfully obtained. For keeping the TA being aligned between UE and the network, there are at least one of the following mechanisms for UL Time Advance Sync MAC CE:
TA synchronization may be triggered and pending by a successful reception and decoding of the RAR on the candidate cell 806.
A MAC entity may generate the UL TA Sync MAC CE when there is available UL-SCH on the serving cell 804 which can accommodate the UL TA Sync MAC CE. In some example implementation, the current serving cell 804 may be an SpCell. In some other implementations, the current serving cell 804 may be either an SCell or an SpCell.
If there is no UL-SCH resources available for accommodating the UL TA sync MAC CE, an SR may be triggered and pending.
the TAT may be restarted/started when the UL TA Sync MAC CE MAC CE is sent to the network.

In some example implementations, the UL time Advance Sync MAC CE above may contain at least one of the following fields:
TA value to indicate the TA value of the candidate cell 806 and/or Time Advance Group (TAG) to the current serving cell 804.
Candidate Cell information, to indicate the candidate cell where the TA is obtained.
TAG information to indicate the TAG the obtained TA is for.
The left TAT length to indicate the left TAT length of the TAT value, the left length of the TAT being calculated based on the time of sending the UL time Advance Sync MAC CE.

In the example implementations above in which RAR is present (e.g., 820 and 830), the TAG may be configured in RRC configuration of the candidate cell (group) or LTM configuration in various example manners. For example, a set of TAGs may be introduced for each candidate cell group, e.g., Assistance TAG (aTAG), and aTAG may be categorized into PaTAG, SaTAG. For another example, only timeAlignmentTimer may be present in the candidate cell group configuration for signaling optimization. For another example, global TAG ID pools may be used to include TAGs for all cells (e.g., all serving cells) in serving cell group and candidate cell group (e.g., all candidate cells). For yet another example, a set of TAGs may be introduced for each candidate DU, which means, candidate (serving) cell groups belonging to the same DU share one TAG ID pool.

In the various example implementations above in which RAR is not present (e.g., implementations of 840 and 850 of FIG. 8), various consideration may be taken into account when determining whether to terminate an early RACH procedure. For example, an information element may be included in the RRC configuration of the candidate cell (group) or LTM configuration to indicate a maximum preamble transmission times for PDCCH ordered early RACH (or early RACH command). The maximum number of transmission times may be tracked independent of other RACH types. The UE may then consider that the early RACH as successfully terminated if the preamble transmission times reach the configured maximum preamble transmission times. For another example, a hard-coded number N for maximum preamble transmission times for early RACH may be specified, e.g., N=1, N=2 . . . etc.

### LTE RACH-Less Like TA Acquisition

In some other example implementations, TA acquisition may be RACH-less rather being based on RACH procedures. For example, TA acquisition may be assumed, may be based on RRC, or may be based on MAC CE.

For example, in some implementations, because of the close proximity of the candidate cell to the UE, the TA of the candidate cell may be assumed to be zero.

For another example, TA of another cell in the same TAG of the target cell may be known. The TA for that cell may be used to approximate the TA for the candidate cell with the assumption that the TAs of the cells within the same TAG are similar.

In some example, the TA for the candidate cell may be provided through RRC. For example, an information element in the RRC configuration associated with the candidate cell may be used to indicate the candidate cell's TA, e.g., as being 0. And if the TA of the candidate cell is indicated as 0, then ID of the TAG to which the candidate cell belongs may not be included in the RRC configuration with respect to the TA. Otherwise, the TAG ID may be included such RRC configuration so that the UE can determine using TA of another cell within the TAG, if known, as the TA for the candidate cell.

Likewise, the TA for the candidate cell may be provided through MAC CE. For example, a filed in a cell switching MAC CE may be included to indicate the TAG to which the candidate cell belongs so that the UE can approximate the TA of the candidate cell using TA of one of the cells within the TAG, if known. For another example, a field in the cell switching MAC CE may be included and used to directly indicate the TA of the candidate cell.

### LTM Switching Procedures

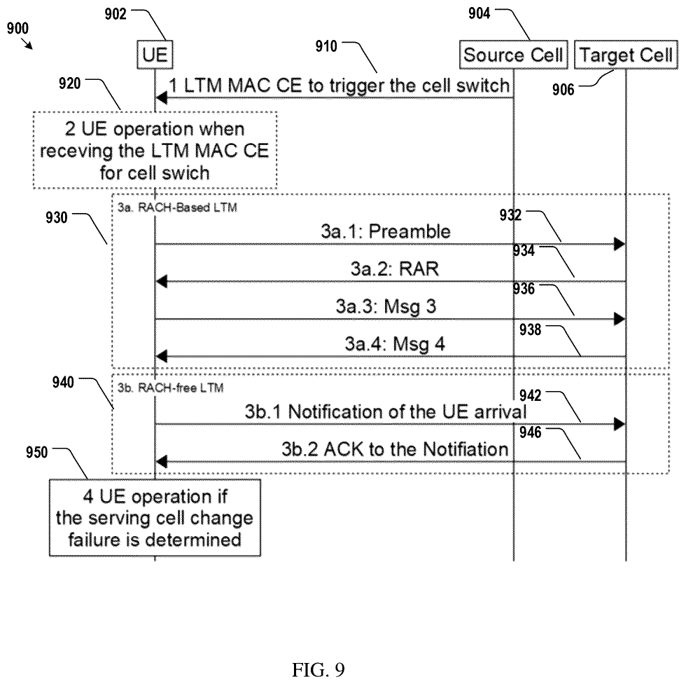

As described above, LTM based cell switch may be RACH-based or RACH-free, and the TA of the candidate or target cell obtained in the various example manners above may be used for uplink transmission timing in the RACH-free LTM. Otherwise, the TA may be obtained through the RACH procedure in a RACH-based LTM switching. Example general steps for LTM switching procedure are illustrated in flow chart 900 of FIG. 9, including:
STEP 1: The source cell 904 may first send an LTM initiation command, e.g., an LTM MAC CE, to the UE 902 for triggering an LTM, as shown by 910.
STEP 2: The UE 902 may then perform one or more operations for the cell switch according to the received LTM MAC CE, as indicated by 920.
STEP 3: The UE 902 and the target cell 906 may then interact to establish communication and complete the cell switch either via a RACH-based procedure (as shown by 930) or a RACH-free procedure (as shown by 940), as described in further detail below.
STEP 4: If the UE 902 determines that cell switch fails, it may further perform a set of operations as described in detail below.

For STEP 1 shown by 910, the LTM MAC CE in L2 from the source cell 904 to the UE 902 may include at least one of the following information items:
Target Cell Group Configuration ID to indicate a target cell group that the target cell 906 belongs to.
Target SpCell ID to identify the target cell 906 that the UE 902 is to switch in.
L2 (layer-2) Reset Indication to indicate whether the L2 reset is needed or not.
Bandwidth Part (BWP) ID to indicate a UL BWP and a DL BWP of the target cell that is to be used when the UE 902 switches in.
TA field to indicate the TA value of the target cell 906. In some example implementations, if RAR in indicated as being available according to an indication associated with the candidate cell group, the TA field here may be reserved for R bits.
Cell Radio Network Temporal Identifier (C-RNTI) to indicate the C-RNTI that is used by the UE 902 when accessing the target cell 906. In some example implementations, it may be optionally present. If the C-RNTI value is present in the RRC configuration associated with target cell 906, this field may be reserved for the R bits.

The STEP 2 (920 of FIG. 9), one or more operations for the cell switch may be performed by the UE 902 according to the LTM MAC CE or LTM switching command 910 in STEP 1. For example, the one or more operations may include an L2 reset if it is so indicated in the LTM MAC CE.

In some example implementations, at least one of the following operations associated with L2 reset may be adopted:
PDCP Recovery for an Acknowledge Mode (AM) Data Radio Bearer (DRB), if any.
An RLC reestablishment for all data radio bearers.
A full MAC Reset.

Otherwise, if an L2 reset is not indicated by the LTM MAC CE 910, the UE 902 may perform an adaptive MAC reset or partial MAC reset or LTM MAC reset

In the example implementations above, an adaptive MAC reset may be a subset of the full MAC reset. The full MAC reset operations may be categorized into the following categories:
MAC reset operations handled by a MAC Entity including but not limited to:
   Stop ongoing Random-Access procedure if any;
   Discard explicitly signaled contention-free Random-Access Resources for 4-step RA type and 2-step RA type, if any;
   Flush Msg3 buffer for the 4-step RA (e.g., the procedure of FIG. 5);
   Flush MSGA buffer of the 2-step RA;
   Release, if any, Temporary C-RNTI.
MAC Reset Operations handled per HARQ entity:
   Flush Msg 3 buffer for the 4-step RA (e.g., the procedure of FIG. 5);
   Flush MSGA buffer of the 2-step RA; set the NDIs for all uplink HARQ processes to the value 0;
   Flush the soft buffers for all DL and UL HARQ processes;
   For each DL HARQ process, consider the next received transmission for a TB as the very first transmission.
MAC reset operations handled per logical channel:
   Initialize Bj for each logical channel to zero;
   Cancel, if any, triggered recommended bit rate query procedure; or
   Cancel, if any, triggered Buffer Status Reporting procedure;
   Cancel, if any, triggered Scheduling Request procedure.
MAC reset operations handled per CC/BWP:
   Cancel, if any, triggered Power Headroom Reporting procedure;
   Cancel, if any, triggered consistent Listen Before Talk (LBT) failure;
   Cancel, if any, triggered Beam Failure Recovery (BFR);
   Cancel, if any, triggered Configured uplink grant confirmation;
   Cancel, if any, triggered Desired Guard Symbol query;
   Reset all Beam Failure Indicator (BFI) counters; or
   Reset all LBT counters.
MAC reset operations handled per TAG:
   Consider all time_Alignment_Timers as expired and perform the corresponding actions.

Based on each of the categories of MAC reset operations above, several general considerations may be included in the implementation of MAC reset in LTM, including but not limited to:
All MAC reset operation items in the categories handled per MAC entity may be included as being effective in the LTM MAC reset.
All MAC Reset operation items in the categories handled per HARQ entity may be included as being effective in the LTM MAC Reset.
All MAC Reset operation items in the categories handled per LCH other than ‘Cancel, if any, triggered Scheduling Request Procedure’ may be included as being effective in the LTM MAC Rest if the associated DRB is modified/released by considering the pre-configured LTM configuration. In one implementation, the DRBs that are included in either drbtoAddmodList or SCelltoReleaseList may be considered as being modified/released. In another implementation, for intra-DU LTM, the DRBs may be considered as not being modified/released.
All MAC reset operations in the categories handled per CC/BWP may be included as being effective in the LTM MAC reset to the serving cells that are modified/released by considering to apply the pre-configured candidate cell group configuration for LTM. In one implementation, the serving cells may be the SCells that are included in either SCelltoAddModList or

SCelltoReleaseList to be considered as being modified/released. In another implementation, the serving cells may be the SpCell that is considered as being modified/released.
For the MAC reset operations in the category handled per TAG, it shall not be included in the LTM MAC Reset.
For the timer operation, stop all the timers related to the cancelled MAC procedure.

For a partial MAC Reset or LTM MAC Reset, it may include at least one of the following information:
Stop ongoing Random-Access procedure if any;
Discard explicitly signaled contention-free Random-Access Resources for 4-step RA type and 2-step RA type, if any;
Flush Msg 3 buffer for the 4-step RA (e.g., the procedure of FIG. 5);
Flush MSGA buffer of the 2-step RA;
Release, if any, Temporary C-RNTI;
Set the NDIs for all uplink HARQ processes to the value 0;
Flush the soft buffers for all DL and UL HARQ processes;
For each DL HARQ process, consider the next received transmission for a TB as the very first transmission
Cancel, if any, triggered Scheduling Request procedure;
If the DRB an LCH is associated with is released and/or modified by considering the pre-configured LTM configuration, at least one of the following MAC operation is included:
   Initialize Bj for the logical channel to zero;
   Cancel, if any, triggered recommended bit rate query procedure;
If a serving cell is released and/or modified by considering the pre-configured LTM configuration, at least one of the following MAC operation is included:
   Cancel, if any, triggered Power Headroom Reporting procedure for the serving cell;
   Cancel, if any, triggered consistent Listen Before Talk (LBT) failure for the serving cell, and/or reset the corresponding LBT_COUNTER;
   Cancel, if any, triggered Beam Failure Recovery (BFR) for the serving cell, and or reset the corresponding BFI-COUNTER
   Cancel, if any, triggered Configured uplink grant confirmation for the serving cell.
   Cancel, if any, triggered Desired Guard Symbol query for the serving cell.

For STEP 3 (930 or 940 of FIG. 9), the manner in which the RACH-based LTM procedure (930) or RACH-free (or RACH-less) LTM procedure may be selected in the following manners:
In some example implementations, if the TA value maintained at UE side is valid for the TAG to which the target cell belongs, the RACH-free or RACH-less LTM may be selected. Otherwise the RACH-based LTM is selected.
In some other example implementations, if the TA value is not present either in the LTM MAC CE or in the RRC configuration of the target cell, then the RACH-based LTM may be selected. Otherwise, the RACH-free or RACH-less LTM is selected.

For the RACH-based LTM 930 including STEPS 3a, the detailed steps 932 through 938 may follow the general 4-step RACH process of FIG. 5, including, for example:
The UE 902 may select and send the preamble to the target cell in 932. The RACH preamble ID maybe selected upon the reference signal ID indicated in the LTM MAC CE through a reference signal to RACH preamble mapping.
The target cell 906 may send the RAR to UE in 934.
The UE 902 may send an Msg 3 to the target cell 906 with the UL grant included in the RAR.
The Target cell 906 may send an Msg 4 to the UE 902.

The LTM procedure may be considered successful when the RACH procedure 930 is successfully completed and terminated.

For the RACH-free or RACH-less LTM 940 including STEPS 3b.1 (942) and 3b.2 (944). In STEP 3b.1, as shown in 942, the UE 902 sends a notification of UE arrival to the target cell 906. In STEP 3b.2, the UE 902 receive an acknowledgement of the notification from the target cell 906. The notification of the UE arrival in 942, for example, may include at least one of the following:
Using the configured grant type 1 to carry the C-RNTI MAC CE, each type 1 configured grant being associated with a reference signal (e.g., Configured Grant Small Data Transmission (CG-SDT) like solution). In one implementation, the reference signaling may be an SSB or a CSI-RS.
Send to the target cell with an SRS which has been associated with a reference signal or a TCI State ID in the SRS-Config of the target cell. In one implementation, the reference signaling may be an SSB or a CSI-RS.

For STEP 4, as indicated in 950 of FIG. 9, the UE may determine whether the cell switch has failed or not based on network acknowledgement or NACK. The network acknowledgement or NACK may be received or deemed in the following example manners:
A determination of successful LTM may be based on network acknowledged response to the notification from the target cell 906:
   If the LTM is the RACH based LTM, the successful termination of the RACH procedure may serve as the network acknowledge response.
   If the LTM is RACH-free LTM, a reception of a DCI scrambled with the new C-RNTI may be considered as the network acknowledge response.
   A reception of the DL MAC CE may be considered as the network acknowledgement response.
A determination of failure of LTM may be based on network NACK response:
   If the LTM is the RACH based LTM, the failure of the RACH procedure may be used as a NACK response.
   If the LTM is RACH-free LTM, an expiration of a timer may be deemed as network NACK response.

When the acknowledgment is received from the network and or acknowledgement is determined by the UE, the LTM procedure is considered as successful terminated. However, when a NACK is received from the network or a NACK is determined by UE, the LTM is considered as unsuccessful. The UE deems the LTM procedure unsuccessful, the following example procedure may be further adopted:
The UE may trigger the RRC re-establishment procedure.
The UE may revert back to the source serving cell (e.g., to perform a cell switch automatically back to source cell by apply the pre-configured cell group configuration associated with the source cell (group)).
UE may perform the a next LTM to the next candidate cell randomly or sequentially if more than one candidate target cells are provided in the LTM MAC CE or the candidate cell group configuration.

In some example implementations, additional procedures or considerations may be adopted after the LTM cell switch above to target SCell. Such SCell operations/considerations may include but are not limited to:
Consider the SCells as being activated during the LTM based Cell switch when those SCells are not present either in the SCelltoReleaslist or in the SCellToAddModList in the candidate cell group configuration.
Consider the SCells as being activated during the LTM based Cell Switch according to the indication from LTM MAC CE, for example, LTM MAC CE may include the bitmap of the SCell indication.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method performed by a wireless terminal, the method comprising:
receiving, from a current serving cell, a time advance (TA) configuration for assisting in an acquisition of acquiring a time advance (TA) associated with a candidate cell;
acquiring the TA according to the TA configuration;
receiving a layer 1/layer 2 triggered mobility (LTM) command, the LTM command instructing the wireless terminal to perform a cell switch to the candidate cell; and
performing a random-access-free cell switch from the current serving cell to the candidate cell according to the LTM command.

2. The method of claim 1, wherein acquiring the TA according to the TA configuration comprises performing an early random-access procedure on the candidate cell.

3-12. (canceled)

13. The method of claim 1, wherein the current serving cell is associated with a first distributed unit base station and the candidate cell is provisioned by associated with a second distributed unit base station, the second distributed unit base station being different from the first distributed unit base station.

14. The method of claim 13, wherein the TA configuration originates from the second distributed unit base station and is transmitted to the first distributed unit base station via a central unit base station.

15-23. (canceled)

24. A wireless terminal comprising a processor and a memory, wherein the processor is configured to read computer code from the memory to cause the wireless terminal to:
receive, from a current serving cell of the wireless terminal, a time advance (TA) configuration for acquiring a time advance (TA) associated with a candidate cell;
acquire the TA according to the TA configuration;
receive a layer 1/layer 2 triggered mobility (LTM) command, the LTM command instructing the wireless terminal to perform a cell switch to the candidate cell; and
perform a random-access-free cell switch from the current serving cell to the candidate cell according to the LTM command.

25-26. (canceled)

27. The method of claim 14, wherein: after the TA configuration is transmitted to the first distributed unit base station, the wireless terminal receives the TA configuration from the first distributed unit base station.

28. The method of claim 13, wherein:
a first message comprising early sync information is transmitted to the second distributed unit base station, wherein a second message is generated by the second distributed unit base station, the second message is in response to the first message, and the second message comprises the early sync information.

29. The method of claim 28, wherein:
an early RACH configuration comprising early syn information of the candidate cell is transmitted to the first distributed unit base station.

30. The method of claim 13, wherein:
a first message is transmitted by the second distributed unit base station, via a central unit base station, to the second distributed unit base station, wherein the first message comprises TA information.

31. The method of claim 1, further comprising:
performing an early random-access procedure on the candidate cell according to the TA configuration.

32. The method of claim 31, wherein the performing the early random-access procedure comprises:
transmitting a RACH preamble to the candidate cell, and
upon transmitting the RACH preamble, considering the early random-access procedure as terminated without monitoring for a random access response (RAR).

33. The wireless terminal of claim 24, wherein: when the processor is configured to cause the wireless terminal to acquire the TA according to the TA configuration, the processor is configured to cause the wireless terminal to perform an early random-access procedure on the candidate cell.

34. The wireless terminal of claim 24, wherein the current serving cell is associated with a first distributed unit base station and the candidate cell is associated with a second distributed unit base station, the second distributed unit base station being different from the first distributed unit base station.

35. The wireless terminal of claim 34, wherein the TA configuration originates from the second distributed unit base station and is transmitted to the first distributed unit base station via a central unit base station.

36. The wireless terminal of claim 34, wherein a first message comprising early sync information is transmitted to the second distributed unit base station, wherein a second message is generated by the second distributed unit base station, the second message is in response to the first message, and the second message comprises the early sync information.

37. The wireless terminal of claim 36, wherein an early RACH configuration comprising early syn information of the candidate cell is transmitted to the first distributed unit base station.

38. The wireless terminal of claim 34, wherein a first message is transmitted by the second distributed unit base station, via a central unit base station, to the second distributed unit base station, wherein the first message comprises TA information.

39. The wireless terminal of claim 24, wherein the processor is configured to further cause the wireless terminal to perform an early random-access procedure on the candidate cell according to the TA configuration.

40. The wireless terminal of claim 39, wherein: when the processor is configured to cause the wireless terminal to perform the early random-access procedure, the processor is configured to cause the wireless terminal to:
transmit a RACH preamble to the candidate cell, and
upon transmitting the RACH preamble, consider the early random-access procedure as terminated without monitoring for a random access response (RAR).

41. A non-transitory computer-readable medium storing instructions, wherein, the instructions, when executed by a wireless terminal, are configured to cause the wireless terminal to:
receive, from a current serving cell, a time advance (TA) configuration for acquiring a time advance (TA) associated with a candidate cell;
acquire the TA according to the TA configuration;
receive a layer 1/layer 2 triggered mobility (LTM) command, the LTM command instructing the wireless terminal to perform a cell switch to the candidate cell; and
perform a random-access-free cell switch from the current serving cell to the candidate cell according to the LTM command.
